(19) United States
(12) Patent Application Publication
(10) Pub. No.: US 2023/0041816 A1
(43) Pub. Date: Feb. 9, 2023

(54) FOOD PRODUCT COMPRISING A MUCILAGINOUS HYDROCOLLOID

(71) Applicant: LO-DOUGH LIMITED, Greater Manchester (GB)

(72) Inventors: Robert WALES, Greater Manchester (GB); Ben HOLDEN, Manchester (GB)

(21) Appl. No.: 17/633,957

(22) PCT Filed: Jul. 31, 2020
(86) PCT No.: PCT/GB2020/051843

§ 371 Date: Feb. 8, 2022

(30) Foreign Application Priority Data
Jul. 31, 2019 (GB) 1910913.1

(51) Int. Cl. A21D 13/062; A21D 13/066; A21D 2/26; A23L 33/21; A21D 13/02; A21D 2/36; A21D 10/00; A21D 2/18

(52) U.S. Cl. CPC A21D 13/062; A21D 13/066; A21D 2/266; A23L 33/21; A21D 13/02; A21D 2/36; A21D 10/005; A21D 2/188; A23V 2002/00

(57) ABSTRACT

The present invention relates to a bakery food product produced from a mucilaginous hydrocolloid and a mannan-based hydrocolloid. The bakery food product is low fat and has a long shelf life, and a higher water resistance than traditional dough based foods. Also provided is a method for making the bakery food product, and a liquid mixture for making a bakery product. Also provided are dehydrated food products produced from a mucilaginous hydrocolloid and a mannan-based hydrocolloid.

The present invention relates to a food product, a food ingredient, and a liquid mixture for making a food product. The present invention also relates to a meal item comprising a food product or ingredient of the invention. The invention also relates to a method for making a food product, a food ingredient and a liquid mixture.

### BACKGROUND

Excess calorie intake has been linked to obesity and various diseases including diabetes. Additionally, obesity is often seen as unattractive amongst many Eastern and Western populations. For these reasons there is a need for food products which have a reduced calorie content. Reduction in calorie content may be achieved by reducing the fat content or reducing the carbohydrate content of a food product. More recently, since certain fats have been recognised as being important to a healthy lifestyle, low carbohydrate diets have become popular in order to reduce weight gain, lose excess weight and to maintain a healthy weight.

Carbohydrate based foods are an important component of the Western diet. Such food products are generally made from plain or wholemeal flour, yeast and water. Fat and sugar may also be added. Due to the carbohydrate content, such foods have a high calorie density, often reaching and even exceeding 500 kcal per 100 grams. Convenience foods such as pizzas and bread based products play an important role in a Western diet, but are generally carbohydrate based and high in calories.

For environmental and health reasons, there is also a growing trend toward vegetarian and vegan diets.

The present invention aims to provide a food product which addresses or ameliorates the aforementioned problems.

### BRIEF SUMMARY OF THE DISCLOSURE

In a first aspect, the present invention provides a food product comprising a mucilaginous hydrocolloid, a mannan-based hydrocolloid, plant derived protein, insoluble fibre and water. Suitably, the food product is low in carbohydrate. Suitably, the food product does not comprise grains.

In a suitable embodiment, the food product of the first aspect is low in fat, suitably comprising less than 3% by weight of fat.

In a suitable embodiment, the food product of the first aspect does not contain egg. Suitably, the food product does not comprise animal product, and is suitably vegan.

In a second aspect, there is provided a granular food ingredient comprising a mucilaginous hydrocolloid, a mannan-based hydrocolloid, a plant derived protein, and insoluble fibre. Suitably, the food ingredient may also comprise water. Alternatively, the granular food ingredient may be a substantially dehydrated food ingredient.

In a suitable embodiment, the granular food ingredient of the second aspect does not contain comprise animal product, and suitably is vegan.

In a third aspect, the present invention provides a method of making a food product, the method comprising the steps of:
i) mixing a mucilaginous hydrocolloid, a mannan-based hydrocolloid, insoluble fibre, a plant derived protein and water to provide a liquid mixture;
ii) optionally, applying the liquid mixture onto a baking sheet;
iii) heating the liquid mixture to remove water and provide a substantially dehydrated food product.
iv) optionally re-hydrating the dehydrated food product of iv).

The method may further comprise the step of forming the food product into shapes. The method may further comprise the step of grinding the food product of iii) or a rehydrated food product of iv) to produce a granular food ingredient of the second aspect. Therefore, the present invention also provides a method of making a granular food ingredient of the second aspect.

In an embodiment, step i) of the method of the invention may comprise two or more steps, each step comprising mixing two or more of the defined ingredients. Any two or more of the mucilaginous hydrocolloid, a mannan-based hydrocolloid, insoluble fibre, a plant derived protein and water any additional ingredients may be combined simultaneously, sequentially, or separately. For example, a mucilaginous hydrocolloid and mannan-based hydrocolloid may be mixed prior to addition of insoluble fibre, water and a plant derived protein.

In a fourth aspect, the present invention provides a liquid mixture comprising a mucilaginous hydrocolloid, a mannan-based hydrocolloid, plant derived protein, insoluble fibre, and water.

In a suitable embodiment, the liquid mixture of the fourth aspect does not contain comprise animal product, and is suitably vegan.

In a fifth aspect, the present invention provides a dehydrated food product comprising a mucilaginous hydrocolloid, a mannan-based hydrocolloid, plant derived protein and insoluble fibre.

Suitably, the dehydrated food product is low in carbohydrate, and suitably does not comprise grain. Suitably, the dehydrated food product comprises less than 15, 12, 10, 9, 8, 7, 6, 5, 4, or 3% carbohydrate. Suitably, the food product does not comprise carbohydrate from any source other than the mucilaginous hydrocolloid and mannan-based hydrocolloids.

In a suitable embodiment, the food product of the fifth aspect is low in fat, suitably comprising less than 3% by weight of fat.

In a suitable embodiment, the dehydrated food product of the fifth aspect does not contain egg. Suitably, the food product does not comprise animal product, and is suitably vegan.

A dehydrated food product of the invention may be produced according to a method of steps i) to iii) of the third aspect.

In a sixth aspect, the present invention provides a meal item comprising:
a food product of the first aspect of the invention, a granular food ingredient of the second aspect; and/or a dehydrated food product of the fifth aspect of the invention; and
one or more additional ingredients, toppings, fillings, dressings, sauces, and/or spreads.

In a seventh aspect, the present invention provides a long shelf life food product comprising a food product of the first aspect of the invention, a granular food ingredient of the second aspect; and/or a dehydrated food product of the fourth aspect of the invention.

In an eighth aspect, the present invention provides a culinary mix comprising two or more ingredients for making a food, wherein one or more of the ingredients is a granular food ingredient of the second aspect. A culinary mix may comprise other food ingredients, such as sugar, artificial sweetener, cocoa, flavouring, colouring, fats, baking powder, salt or egg.

### DETAILED DESCRIPTION

The present invention is based on the surprising finding that a composition comprising a mucilaginous hydrocolloid, a mannan-based hydrocolloid, plant derived protein, insoluble fibre, and water may be used to form a liquid mixture, which can be used as the basis for manufacturing a variety of food products which are traditionally made from dough. The inventors have surprisingly found that food products of the invention may have a higher water resistance than traditional dough based foods high in carbohydrates such as breads, rolls, pizza bases, wraps, crackers, etc and compared to low carbohydrate products. This unique property allows the food products of the invention to maintain their structural integrity for longer periods of time in the presence of moist fillings, dressing, sauces, etc. This is particularly relevant for the convenience or ready-made food market.

Additionally, the inventors have surprisingly found that the food product or ingredient of the invention may be able to withstand a sterilisation process (for example sterilisation by retort), allowing the product to have a long shelf life. This property is especially important in the context of a bakery food product, which traditionally has a short shelf life often leading to significant amounts of bakery food products being wasted. The inventors have found that the food product of the invention comprising the ingredients and/or made according to the methods discussed elsewhere in this specification, are able to withstand a sterilisation process.

Additionally, providing a granular food ingredient offers an advantage in terms of supply chain and transportation compared to prepared or ready-made food products. Dry bulk ingredients are easier to transport and use less physical space than prepared foods offering an advantage to supply chain. This is particularly relevant to the health food market and food manufacturing industry.

The present invention is based on the surprising production of a vegan food product, which can be used in place of a food product traditionally made from dough.

### General

The following definitions and embodiments may apply to all aspects and embodiments of the invention, either individually or in any combination.

The food products, ingredients, liquid mixtures, meal items, long shelf life products and culinary mixes of the invention are suitable for consumption by humans (adults and/or children). A food product of the invention intended for human consumption does not include food products intended for animal consumption, for example non-human animals such as farm animals (such as cows, sheep, goats, etc) or domestic animals (such as cats and dogs). A food product of the invention for human consumption may therefore exclude food items such as animal dry meals, animal biscuits and animal treats.

A food product or ingredient of the invention is a low carbohydrate product. The term “carbohydrate” refers to a carbohydrate which is digestible and/or absorbable by humans. Accordingly, carbohydrates derived from fibres which may not be digested or absorbed by humans are not encompassed by the term “carbohydrate” in this specification. The “carbohydrate” content of the food product or ingredient may be substantially derived from a mucilaginous hydrocolloid. By “low carbohydrate” it is meant that the food product or ingredient has a carbohydrate content of 15, 14, 13, 12, 11, 10, 9, 8, 7, 6, 5, 4, 3, 2, or 1 gram(s) or less per 100 grams. Suitably, the food product or ingredient has a carbohydrate content of about 3, 4 5, 6, 7, 8, 9 or 10 gram or less per 100 grams. Therefore, a food product or ingredient comprises less than 15, 12, 10, 9, 8, 7, 6, 5, 4, 3, 2 or 1% carbohydrate. Suitably, the food ingredient does not comprise carbohydrate from any source other than the mucilaginous hydrocolloid and mannan-based hydrocolloids. Suitably, when a food product or ingredient of the invention is a bakery food product, ingredient or liquid mixture, it may have a carbohydrate content of about 6-8 grams or less per 100 grams.

The food product or ingredient of the invention may be a low-calorie product. A calorie as used herein is an approximate amount of energy needed to raise the temperature of one gram of water by one degree Celsius at a pressure of one atmosphere. A kilocalorie (kcal) is 1000 calories. By “low calorie” it is meant that the food product or ingredient may have a calorie content of less than 300, 250, 150, 100, 90, 80, 70, 60, or 50 kcal per 100 grams. Suitably, when the food product is a bakery food product, it may have a calorie content of 150 kcal or less per 100 grams.

The food product or ingredient of the invention may be a low fat product. By “low fat” it is meant that the food product or ingredient has a fat content of less than 3, 2.8, 2.6, 2.4, 2.2, 2, 1.8, 1.6, 1.4, 1.2, 1, 0.8, 0.6, 0.4, or 0.2 grams of fat per 100 grams. In other terms, it can be said the food product or ingredient of the invention comprises less than 3%, 2.8%, 2.6%, 2.4%, 2.2%, 2%, 1.8%, 1.6%, 1.4%, 1.2%, 1%, 0.8%, 0.6%, 0.4%, or 0.2% by weight of fat.

Suitably, the food product or ingredient of the invention may be substantially fat free. By “substantially fat free” it is meant that the fat content of the food product or ingredient of the invention is less than 1 grams of fat per 100 grams, more suitably about 0.5 grams or less per 100 grams by weight of fat. The term “fat” refers to triglyceride molecules naturally found within the ingredients described herein.

The food product or ingredient of the invention may be a high fibre product. By “high fibre” it is meant that the food product or ingredient has a fibre content of about 20, 25, 30, 35 or 40 grams of fibre per 100 grams. It will be appreciated the fibre content may be derived not only from the insoluble fibre, but also from the mucilaginous hydrocolloid (such as psyllium), the mannan-based hydrocolloid (for example konjac), and/or a texture enhancer (for example hydroxypropylmethylcellulose), if such a texture enhancer is present.

The term “mucilaginous hydrocolloid” refers to a hydrocolloid substance comprising polymers of one or more monosaccharides, which when exposed to a fluid (such as water) forms a slimy mass. By way of example, a mucilaginous hydrocolloid may be obtained from a plant, in particular from a seed of a plant, in particular from a seed husk. Suitable mucilaginous hydrocolloids may include psyllium, linseed (also known as flaxseed), and chia seed.

The term “psyllium” as used herein, refers to the seed from plants of the Plantago genus. Suitable seeds may be obtained from various Plantago species, including without limitation P. laceolate, P. rugelii and P. major. Other suitable species will be known to the person skilled in the art. Reference to psyllium includes intact whole seeds and/or milled seeds, and intact or milled seed husks. Milled seeds or husks may of any suitable degree of coarseness, for example a rough or a fine powder.

The term “mannan-based hydrocolloid” refers to a hydrocolloid substance comprising a mannan, in particular a glucomannan and/or a galactomannan. Suitably, a mannan based hydrocolloid is a plant derived hydrocolloid. A mannan-based hydrocolloid may suitably be high in mannan content, for example comprise at least 30% by weight of mannan. An example of a hydrocolloid substance high in glucomannan is konjac. Examples of hydrocolloids high in galactomannan include locust bean gum, guar gum, carob tree, carob bean gum, senna gum, tara gum and fenugreek gum. Other suitable mannan-based hydrocolloids which may be used in the present invention will be known to the skilled person.

For the purpose of the present invention, xanthum gum is not considered to be a mannan based hydrocolloid or plant derived hydrocolloid. In a suitable embodiment, a food product, ingredient, liquid mixture does not comprise xanthan gum as the mannan based hydrocolloid. Therefore if xanthum gum is present, it may be present at less than 0.5%, or suitably less than the defined percentage of mannan based hydrocolloid. In a suitable embodiment, a food product, ingredient, or liquid mixture of the invention does not comprise xanthan gum.

The term “konjac” as used herein, refers to a plant of the genus Amorphophallus. Suitably “konjac” may refer to the tubers of the Amorphophallus plant. Suitably, the tubers may be ground. Suitably ground tubers may be in the form of konjac flour.

The term “plant derived protein” as used herein refers to protein that is derived from any plant or plant material, such as, legumes mushrooms, seeds, nuts, seaweed or algae, potato, or grains, or a combination thereof. Suitably, a plant derived protein does not contain animal products and would therefore be suitable for a vegan or plant based diet. Suitable legumes include, without limitation, chickpea, mung bean, adzuki bean, kidney bean, navy bean, pinto bean, peas (for example split peas such as yellow peas (Pisum sativum) or green peas, black eyed peas), lentils (for example green, brown, red, or yellow lentils, or puy lentils, or combinations thereof), broad beans, bambara groundnut, soy beans, great northern beans, lima beans, and butter beans, or any combination thereof. A suitable plant protein may be a legume protein isolate, for example from the family Fabacceae, for example a grain legume. Examples of legumes include Glycine max (soybean), Phaseolus (beans), Pisum sativum (pea), Cicerariettinum (chickpeas), Medicago sativa (alfalfa), Arachis hypogaea (peanut). Also included are combinations of any two or more legume proteins, for example pea and soy, pea and bean (e.g. mung bean), or two or more varieties of pea (e.g. garden pea and chickpea), or two or more types of bean (e.g. soy bean and mung bean). A suitable plant protein may be any member of the family, in particular, Pisum sativum and any varieties thereof such as garden pea, snow pea, etc. Suitable nut sources of protein include, without limitation, almond, walnut, pistachio, peanut, or any combination thereof. Suitable seed sources of protein include, without limitation, chia, sunflower, flax and hemp, or combinations thereof. Suitable seaweed sources of protein include, without limitation, kelp, wakame, spirulina, or combinations thereof. Suitably, potato skin may be used. Suitable mushroom sources of protein include shiitake. A plant derived protein may be from any combination of two or more protein sources, as described above.

Suitably, a plant-derived protein is provided in the form of a protein isolate, containing 70% or more protein. Suitably, the isolate contains 75%, 80%, 85% or 90% or more plant protein. The plant derived protein may be a dry powder. Suitably a binding agent may be a dry powder reconstituted in water. A suitable plant protein may be a legume protein isolate, comprising 70%, 75% or 80% or more legume derived protein. A suitable plant protein may be a pea or bean protein isolate, as described herein, comprising 70%, 75% or 80% or more pea or bean derived protein. Where two or more protein sources are used, they may each individually contain 70%, 75%, 80%, 85% or 90% or more protein.

In a suitable embodiment, a plant protein is derived from pea or bean or a combination thereof. Suitably, the plant protein may be chickpea isolate, mung bean isolate, soy bean isolate or pea protein isolate. Suitably, a plant protein may comprise any combination of two or more pea or bean proteins, suitably selected from the group consisting of chickpea, pea, mung bean, and soy bean. In a suitable embodiment, the plant protein is not derived from nut.

Where a plant derived protein is reconstituted in a suitable liquid, such as water, it may be reconstituted in a liquid at a ratio of between 5 and 30% of protein powder: between 95% and 70% liquid, respectively; more suitably between 10 and 20% of protein powder: between 90% and 80% of liquid, respectively; most suitably approximately 12.5% of protein powder: approximately 87.5% of water. Therefore, in such an embodiment, 100 grams of binding agent is obtained from 12.5 grams of a plant protein powder and 87.5 grams of water.

The term “water” as used herein refers to pure water as well as a water based liquid. A water based liquid may comprise at least 70%, 75%, 80%, 85%, 90%, 95%, or at least 99% water. A water based liquid may comprise food enhancers. Examples of suitable food enhancers are described herein.

The term “insoluble fibre” as used herein, refers to fibre which is essentially insoluble in water. In the context of the present invention, suitable insoluble fibre may be selected from the group consisting of: wheat fibre, oat fibre, cellulose, hemicellulose and lignin, or a combination thereof. Suitably, the insoluble fibre is wheat fibre.

The term “texture enhancer” as used herein, refers to a substance which has the effect of changing the texture of a food product, for example by increasing or decreasing any aspect of texture including for example the elasticity, density, shape formation and retention, softness, binding, stretchiness, stability of a food, which would have a different texture in the absence of the enhancer. A texture enhancer may suitably serve to increase the similarity between a food product of the invention or a food made from an ingredient of the invention, and a conventional food product (e.g. a food product derived from dough or batter, or made from a grain or flour, for which the food product of the invention may be a substitute of). A texture enhancer is typically an additive rather than a food ingredient. Suitable texture enhancers for use in the present invention may include those which in the presence of a liquid, such as water, increases softness, elasticity and/or stretchiness of a food product compared to the softness, elasticity and/or stretchiness of the food product in the absence of the texture enhancer. A texture enhancer may provide a more bread-like texture. Suitable texture enhancers for use in the present invention will be known to persons skilled in the art, and include for example those which are commonly used as gluten substitutes. By way of example, a texture enhancer may be selected from the group consisting of a cellulose derivative, a gum (such as carrageenan and xanthan gum) and or a starch (such as arrowroot, corn starch and potato starch).

The term “cellulose derivative” refers to a substance obtained by a chemical modification of cellulose. In the context of the present invention, a particularly useful cellulose derivative is hydroxypropylmethylcellulose (HPMC). Other types of cellulose derivatives will be known to the skilled person. Merely by way of example, these may include carboxymethylcellulose, methylcellulose, and hydroxypropyl cellulose.

A food product or ingredient of the invention may comprise at least 70%, 75%, 80%, 85%, 90%, 91%, 92%, 93%, 94%, 95%, 96%, 97%, 98%, or at least 99%, or by weight of a combination of a mucilaginous hydrocolloid, mannan-based hydrocolloid, insoluble fibre, plant derived protein, water and optionally a texture enhancer. Suitably, the food ingredient may comprise at least 90%, suitably between 90% and 95% by weight of a combination of a mucilaginous hydrocolloid, mannan-based hydrocolloid, insoluble fibre, plant derived protein, water and optionally a texture enhancer.

It will be appreciated that when reference is made to the percentage of water in a food ingredient of the first aspect of the invention the percentage does not include the water which may be derived from the plant derived protein, and/or used to reconstitute the protein.

### Food Product

The term “food product” as used herein, encompasses both, a food product of the first aspect of the invention, and a dehydrated food product of the fifth aspect of the invention. The term “food product” refers to foods which are substantially gluten free. The food products of the invention may be used as a substitute for food products which are conventionally made from a dough or a batter. Thus, the food products of the invention may be used as a substitute for food products which conventionally comprise gluten. The food products of the invention may be used as a substitute for food products which conventionally contain flour and/or grains. Thus, food products which traditionally contain flour or grains may be replaced by a food product of the present invention and are included within the scope of the present invention. Such food products include bakery items and/or dried carbohydrate based food products. A food product of the invention may exclude beverages.

A food product of the invention may be a bakery food product. A bakery food product is a food product which is a substitute for a food product conventionally made from a dough or a batter, and which comprises water. Therefore, a bakery food item of the present invention may be similar, or substantially the same, in terms of texture and/or taste to a conventional food product derived from dough or batter. Such conventional food products may include without limitation, pizza bases, wraps, flatbreads, tortillas, breads, cakes, pastries, pancakes, rolls, waffles and biscuits. Therefore, a bakery food product of the invention may be referred to as a “bread-like” product or a “bread substitute”. A bakery food product of the invention may be selected from the group consisting of: pizza bases, wraps, flatbreads, tortillas, breads, cakes, pastries, pancakes, rolls, waffles and biscuits. Herein, and due to the method of manufacture, a bakery food product may also be referred to as a “rehydrated food product”.

A food product of the first and a dehydrated food product of the fourth aspect of the invention may be of any shape. By way of example, a food product of the invention (such as a pizza base, wrap or a cracker) may be circular, square or rectangular in shape. Suitably, the bakery food product of the invention, and in particular a pizza base or a wrap, may be circular in shape.

A food product of the first aspect and a dehydrated food product of the fourth aspect of the invention may be of any size. For example, in the context of a pizza base or a wrap circular in shape, the circle may have a diameter of 1, 2, 4, 5, 6, 7, 8, 9, 10, 11 or more inches. In the context of a cracker rectangular in shape, the rectangle may have a length of 1, 2, 3, 4, 5 or more inches.

### Food Ingredient

The term “food ingredient” as used herein, is an edible substance which is generally not eaten alone but may be used to make food, by combination with one or more other ingredients. Other ingredients include for example sugar, egg, water, milk, flavourings, fat such as butter, lard or oil, meat, vegetables, fruit, cheese, soya, lentils, pulses, and beans etc. A food ingredient of the present invention when combined with one or more other food ingredients may form a homogenous mixture, such that the food ingredient of the invention is not distinguishable from the other ingredients of the mixture. Alternatively or additionally, a food ingredient of the present invention may be used as a coating, topping or filling on or in a food. In such an embodiment, a food ingredient of the invention is distinguishable, or separate (i.e. not homogenous) from one or more other food ingredients making up the food. In the context of the present invention, the term “food ingredient” encompasses a granular food ingredient of the first aspect of the invention. The culinary mix of the second aspect of the invention may comprise a food ingredient of the first aspect of the invention. The term “food ingredient” may refer to a food ingredient which is substantially gluten free.

A food ingredient of the invention may comprise at least 70%, 75%, 80%, 85%, 90%, 91%, 92%, 93%, 94%, 95%, 96%, 97%, 98%, or at least 99% by weight of a combination of a mucilaginous hydrocolloid, mannan-based hydrocolloid, insoluble fibre, binding agent, water and optionally a texture enhancer. Suitably, the food ingredient may comprise at least 90%, suitably between 90% and 95% by weight of a combination of a mucilaginous hydrocolloid, mannan-based hydrocolloid, insoluble fibre, binding agent, water and optionally a texture enhancer.

The term “granular” as used herein refers to a food ingredient that is made up of a population of small particles, or grains, such that it may be or have the appearance of a powder, flour, granules, or breadcrumb. Particles may be referred to as fine or coarse particles. A granular food ingredient may be described as being powdery, grainy, floury, sandy or crumbled. A suitable granular food ingredient may be a powder that in its consistency resembles flour. In another embodiment, a granular food ingredient of the invention may have a consistency which resembles sugar, for example caster sugar or granulated sugar. In another embodiment, a granular food ingredient of the invention may have a consistency which resembles gravy granules. In another embodiment, a suitable granular food ingredient of the invention may have a consistency that resembles breadcrumbs.

In a suitable embodiment, a granular food ingredient of the first, second or third aspect of the invention may have a granule or particle size of about 5 μm to 5 mm. In a suitable embodiment, the granular food ingredient may be used as a flour substitute. In a suitable embodiment, the granular food ingredient may be in the form of a crumb. Suitably, the granular food ingredient may be used as a substitute for a bread crumb.

A granular food ingredient of the invention may comprise granules that range from fine to coarse, such as a flour to a breadcrumb. By way of example, a granular food ingredient may comprise granules that are about 5 μm to 5 mm in diameter, more suitably 10 μm to 4 mm, more suitably 100 μm to 4 mm, more suitably 300 μm to 4 mm; more suitably 500 μm to 4 mm; more suitably 700 μm to 4 mm; more suitably 1 mm to 4 mm; more suitably 1 mm to 3 mm. In a suitable embodiment, a granular food ingredient of the invention may comprise granules that are about 5-50 μm in diameter, 50-100 μm in diameter, 100-200 μm in diameter, 200-300 μm in diameter, 300-400 μm in diameter, 400-500 μm in diameter, 500-600 μm, 600-700 μm, 700-800 μm, 800-900 μm or 900-1000 μm. Suitably, a granular food ingredient of the invention may comprise granules that are about 1-2 mm in diameter, 2-3 mm in diameter, 3-4 mm in diameter or 4-5 mm in diameter.

In a suitable embodiment, a granular food ingredient may comprise a population of particles that are a range of sizes. Suitably, a granular food ingredient of the present invention may comprise a population of particles that are 90% substantially the same size, that are 80% substantially the same size, 70% substantially the same size, 60% substantially the same size, 50% substantially the same size, 40% substantially the same size, 30% substantially the same size, 20% substantially the same size, 10% substantially the same size. Suitably, substantially all the particles in a portion of a food ingredient of the present invention may have substantially the same size. By substantially is meant at least 70%, at least 80%, at least 90%, or at least 95%, 96%, 97%, 98% or 99% of the particles having the same size. By the same size is meant within 10% larger or smaller than a particular range or size. It will be appreciated that a granular food ingredient of the invention may comprise granules of a range of sizes.

It will be appreciated that the skilled person would use the appropriate machinery and time period of grinding to achieve a granular food ingredient having the desired granule size.

Suitably, a granular food ingredient of the invention may be used as a substitute for food ingredients such as flour, starch, rusk, filler, bread crumbs, coatings. Thus, the food ingredient of the invention may be used as a substitute for a food ingredient which conventionally comprises gluten. The food ingredient of the invention may be used to make food products which conventionally contain flour, and/or starch. Thus, food products which traditionally contain flour or starch may be made by replacing the flour or starch with a food ingredient of the present invention, and are included within the scope of the present invention. Such food products include but are not limited to breads or bread crumbs, coatings, cakes, brownies, pancakes, waffles or pastries.

In an embodiment, a food ingredient may exclude a beverage.

### Composition of Food Product and Food Ingredient

A food product or ingredient of the invention may comprise at least 0.3%, 0.5%, 1%, 1.5%, 2%, 2.5%, 3%, 3.5%, 4%, 4.5%, 5%, 6%, 7%, 8%, 9%, 10%, 11%, 12%, 13%, 14%, 15%, or at least 20% by weight of a mucilaginous hydrocolloid. A food product or ingredient may comprise no more than 10%, 15%, 20%, 25%, 30% by weight of a mucilaginous hydrocolloid. Suitably, the food product or ingredient may comprise at least 1% by weight of a mucilaginous hydrocolloid, more suitably between 1.5% and 8% of a mucilaginous hydrocolloid. Where a texture enhancer is present, the food product or ingredient may suitably comprise at least 1% by weight of a mucilaginous hydrocolloid, suitably between 1% and 8% by weight of a mucilaginous hydrocolloid. Suitably, a rehydrated food product or ingredient may comprise 4% to 7% by weight of a mucilaginous hydrocolloid, or more suitably 2% to 5% by weight of a mucilaginous hydrocolloid.

A food product or ingredient of the invention may comprise at least 0.5%, 1%, 1.5%, 2%, 2.5%, 3%, 3.5%, 4%, 4.5%, 5%, 6%, 7%, 8%, 9%, 10%, 11%, 12%, 13%, 14%, 15%, or at least 20% by weight of a mannan-based hydrocolloid. %, 11%, 12%, 13%, 14%, 15%, or at least 20% by weight of a mucilaginous hydrocolloid. A food product or ingredient may comprise no more than 10%, 15%, 20%, 25%, 30% by weight of a mannan-based hydrocolloid. Suitably, the food product or ingredient may comprise at least 1% by weight of a mannan-based hydrocolloid, more suitably between 1.5% and 8% of a mannan-based hydrocolloid. Where a texture enhancer is present, the food product or ingredient may suitably comprise at least 1% by weight of a mannan-based hydrocolloid, suitably between 1% and 8% by weight of a mannan-based hydrocolloid. Suitably, a rehydrated food product or ingredient may comprise 4% to 7% by weight of a mannan based hydrocolloid, or more suitably 2% to 5% by weight of a mannan based hydrocolloid.

A food product or ingredient of the invention may comprise at least 1%, 2%, 3%, 4%, 5%, 6%, 7%, 8%, 9%, 10%, 11%, 12%, 13%, 14%, 15%, 16%, 17%, 18%, 19%, 20%, 25%, or at least 30% or 35% by weight of plant derived protein. Suitably, the food product or ingredient may comprise at least 6% by weight of plant derived protein, suitably between 6% and 10% by weight of plant derived protein. A food product or ingredient may comprise no more than 20%, 25% or 30% or 35% protein. Where a texture enhancer is present, the food product or ingredient suitably may comprise at least 5% by weight of plant derived protein, suitably between 5% and 35% by weight of plant derived protein. In another embodiment, the food product or ingredient may comprise at least 8% by weight of plant derived protein, suitably between 8% and 35% by weight of plant derived protein. Where a texture enhancer is present, the food product or ingredient suitably may comprise at least 10% by weight of plant derived protein, suitably between 8% and 35% by weight of plant derived protein. Suitably, a rehydrated food product or ingredient may comprise 5% to 20% by weight of a plant-based protein, more suitably 10 to 20%.

A food product or ingredient of the invention may comprise at least 5%, 6%, 7% 8%, 9%, 10%, 11%, 12%, 13%, 14%, 15%, 20%, 21%, 22%, 23%, 24%, 25%, 30%, 35%, 40% or at least 45% or 50% by weight of insoluble fibre. A food product or ingredient may comprise no more than 40%, 50%, 60% or 70% insoluble fibre. Suitably, the food product or ingredient may comprise at least 15% by weight of insoluble fibre, more suitably between 15% and 50% by weight, of insoluble fibre. Where a texture enhancer is present, the food product or ingredient may suitably comprise at least 20% by weight of insoluble fibre, suitably between 20% and 50% by weight of insoluble fibre. In another embodiment, the food product or ingredient may comprise at least 20% by weight of insoluble fibre, more suitably between 30% and 60% by weight, of insoluble fibre. Where a texture enhancer is present, the food product or ingredient may suitably comprise at least 25% by weight of insoluble fibre, suitably between 25% and 40% by weight of insoluble fibre. Suitably, a food product ingredient may comprise 40% to 60% by weight of an insoluble fibre.

A food product or ingredient of the invention may comprise no water, or may comprise 1% or more water, for example 1% to 15% or any integer in between, 20%, 25%, 30%, 35%, 40%, 45%, 50%, 52%, 55%, 60%, 61%, 62%, 63%, 64%, 65%, 66%, 67%, 68%, 69%, 70%, 75%, 80%, or 85% by weight of water. Suitably, the food ingredient of the invention may comprise no water, or less than 10%, suitably less than 1%, 2% 3%, 4%, 5%, 6%, 7%, 8% or 9%. Suitably, a food product of the invention may comprise at least 40% by weight of water, suitably between 40% and 70% by weight of water. More suitably, the food product of the invention may comprise at least 40% by weight of water, suitably between 45% and 65% by weight of water.

A food product or ingredient of the first aspect of the invention may comprise at least 0.5%, 1%, 1.5%, 2%, 2.5%, 3%, 3.5%, 4%, 4.5%, 5%, 6%, 7%, 8%, 9%, 10%, 11%, 12%, 13%, 14%, or at least 15% by weight of a texture enhancer. A food product or ingredient may comprise no more than 15%, 20%, 25% or 30% by weight of a texture enhancer. Suitably, the food product may comprise at least 5% by weight of a texture enhancer, suitably between 5% and 10% by weight of a texture enhancer. Suitably, a food ingredient of the invention may comprise 10 to 20% by weight of a texture enhancer, suitably 10-15%. Suitably, a food product of the invention may comprise 5% to 10% by weight of a texture enhancer.

A food product or ingredient of the invention may comprise at least 70%, 75%, 80%, 85%, 90%, 91%, 92%, 93%, 94%, 95%, 96%, 97%, 98%, or at least 99% by weight, of a combination of a mucilaginous hydrocolloid, mannan-based hydrocolloid, insoluble fibre, plant derived protein, water and optionally a texture enhancer. Suitably, the food product or ingredient may comprise at least 90%, suitably between 90% and 95% by weight of a combination of a mucilaginous hydrocolloid, mannan-based hydrocolloid, insoluble fibre, plant derived protein, water and optionally a texture enhancer.

Suitably, a food product or ingredient of the invention may comprise between 1% and 10% by weight of a mucilaginous hydrocolloid, between 1% and 10% by weight of a mannan-based hydrocolloid, between 40% and 60% by weight of insoluble fibre, between 5 and 20% by weight of plant derived protein, and between 40% and 60% of water, and optionally between 5% and 10% by weight of a texture enhancer. Suitably, the mucilaginous hydrocolloid may be psyllium. Suitably, the mannan based hydrocolloid may be konjac. Suitably, the plant based protein may be a legume protein, suitably selected from the group consisting of pea protein, soy bean protein, chickpea protein or mung bean protein, or any combination of two or more thereof.

More suitably, a food product or ingredient of the invention may comprise between 1% and 6% by weight of a mucilaginous hydrocolloid, between 1% and 6% by weight of a mannan-based hydrocolloid, between 40% and 60% by weight of insoluble fibre, between 5 and 25% by weight of plant derived protein, and between 40% and 60% of water, and optionally between 5% and 10% by weight of a texture enhancer. Suitably, the mucilaginous hydrocolloid may be psyllium. Suitably, the mannan based hydrocolloid may be konjac. Suitably, the plant based protein may be a legume protein, suitably selected from the group consisting of pea protein, soy bean protein, chickpea protein or mung bean protein, or any combination of two or more thereof.

Suitably, a food product or ingredient of the invention may comprise between 1% and 4% by weight of a mucilaginous hydrocolloid, between 1% and 4% by weight of a mannan-based hydrocolloid, between 15% and 30% by weight of insoluble fibre, between 5% and 20% by weight of plant derived protein, between 45% and 60% of water, and optionally between 5% and 10% by weight of a texture enhancer. Suitably, the mucilaginous hydrocolloid may be psyllium. Suitably, the mannan based hydrocolloid may be konjac. Suitably, the plant based protein may be a legume protein, suitably selected from the group consisting of pea protein, soy bean protein, chickpea protein or mung bean protein, or any combination of two or more thereof.

More suitably, a food product or ingredient of the invention may comprise from 3% to 5% by weight of a mucilaginous hydrocolloid, from 3% to 5% by weight of a mannan-based hydrocolloid, between 20% and 30% by weight of insoluble fibre, from 10% to 15% by weight of plant derived protein, from 45% to 60% of water, and optionally from 5% to 10% by weight of a texture enhancer. Suitably, the mucilaginous hydrocolloid may be psyllium. Suitably, the mannan based hydrocolloid may be konjac. Suitably, the plant based protein may be a legume protein, suitably selected from the group consisting of pea protein, soy bean protein, chickpea protein or mung bean protein, or any combination of two or more thereof.

In a suitable embodiment, a food product or ingredient of the invention may comprise approximately 2.5% by weight of a mucilaginous hydrocolloid, approximately 2.5% by weight of a mannan-based hydrocolloid, approximately 25% by weight of insoluble fibre, approximately 12% by weight of plant derived protein, approximately 50% by weight of water, and optionally approximately 8% by weight of a texture enhancer. Suitably, the mucilaginous hydrocolloid may be psyllium. Suitably, the mannan based hydrocolloid may be konjac. Suitably, the plant based protein may be a legume protein, suitably selected from the group consisting of pea protein, soy bean protein, chickpea protein or mung bean protein, or any combination of two or more thereof. Suitably, the plant based protein is a pea protein. Suitably, such a food product or ingredient is a food product which has been rehydrated.

### Method of Making a Product or Ingredient

In the third aspect, the invention provides a method of making a food product, the method comprising the steps of:
i) mixing a mucilaginous hydrocolloid, a mannan-based hydrocolloid, insoluble fibre, a plant derived protein and water to provide a liquid mixture;
ii) optionally, applying the liquid mixture onto a baking sheet;
iii) heating the liquid mixture to remove water and provide a substantially dehydrated food product; and
iv) optionally re-hydrating the dehydrated food product of iv)
v) optionally forming the food product into shapes.

The method may be a method for making a food product of the first aspect or a method of making a dehydrated food product of the fifth aspect. Also provided by the present invention is a method of making a liquid mixture of step ii) wherein the method comprises i) mixing a mucilaginous hydrocolloid, a mannan-based hydrocolloid, insoluble fibre, water and optionally a texture enhancer to provide a first mixture; and ii) combining the first mixture with plant derived protein to provide a liquid mixture.

The liquid mixture may be aerated. Aerating the liquid mixture reduces its specific gravity. Suitably, aerating may reduce the specific gravity of the liquid mixture from between 0.7-0.9 to 0.4-0.6. Although there are various methods by which the liquid mixture may be aerated, merely by way of example, the liquid mixture may be aerated by mixing. A Shufflemixer is an example of a mixer suitable for aerating the liquid mixture.

The protein, if provided as a liquid, may be aerated prior to mixing with the remaining ingredients. Any suitable method may be used, for example whisking. “Whisking” as used herein, refers to any form of mixing which serves to aerate a liquid protein. Suitably whisking may result in the formation of a foam. Suitably, the liquid comprising plant protein, before being combined with the first mixture, may be whisked until stiff peaks are formed. The term “stiff peaks” refers to the texture of the foam and can be identified by the formation of peaks in the foam which are maintained despite removal of the whisking implement or movement/upturning of the container in which whisking is performed. In an embodiment, the liquid comprising plant protein may be whisked prior to or after the mixing of step i) or simultaneously with the mixing of step i). Whisking of the liquid comprising plant protein may continue for any suitable period of time until a foam, and suitably stiff peaks are formed. This may be between 10 and 120 seconds. Suitably, whisking maybe for approximately 60 seconds. The timings used may vary in a commercial scale kitchen.

In a suitable embodiment, the mucilaginous hydrocolloid, the mannan-based hydrocolloid, insoluble fibre, water and plant derived protein are all mixed together to provide the liquid mixture.

Accordingly, in one aspect, the invention provides a method of making a bakery food product, the method comprising the steps of:
i) mixing a mucilaginous hydrocolloid, a mannan-based hydrocolloid, insoluble fibre, plant derived protein and water to provide a liquid mixture;
ii) optionally, applying the liquid mixture onto a baking sheet;
iii) heating the liquid mixture to remove water and provide a substantially dehydrated food product; and
iv) optionally re-hydrating the dehydrated food product of iii)
v) optionally forming the food product into shapes.

It will be appreciated that when a mucilaginous hydrocolloid, a mannan-based hydrocolloid, insoluble fibre, plant derived protein and water are mixed to provide a first mixture, the liquid comprising plant protein may be obtained from plant protein powder which has been reconstituted prior to step i), or which is reconstituted in a suitable liquid (e.g. water) during the step of mixing.

It will also be appreciated that when the food product of the first aspect of the invention and the liquid mixture of the fourth aspect of the invention comprise a texture enhancer, these may be obtained according to the method of the third aspect of the invention, where step i) involves mixing a mucilaginous hydrocolloid, mannan-based hydrocolloid, insoluble fibre, water and the texture enhancer. Where step i) and step ii) of the method of the invention are combined into a single step, a mucilaginous hydrocolloid, mannan-based hydrocolloid, insoluble fibre, plant derived protein and water, and optionally the texture enhancer may be mixed together.

The term “mixing” as used herein refers to combining a mucilaginous hydrocolloid, a mannan based hydrocolloid, insoluble fibre, water and plant derived protein (if present) and optionally cellulose derivative and other ingredients until the ingredients are substantially uniformly distributed.

Mixing may be under any suitable conditions. In an embodiment, high shear or high dispersal conditions may be used, for example at a rate of 3000 RPM or more, 4000 RPM or more, or 5000 RPM or more. Mixing may continue for any suitable time period to achieve uniform distribution. A suitable time period may for example be between 1 and 30 seconds. More suitably, mixing may be between 15 and 30 seconds. In an embodiment, mixing continues until the first mixture has reached a viscosity of approximately 40,000 centipoise (cP).

In an embodiment, combining may be performed by blending, stirring or folding. Blending, stirring or folding may continue until the liquid mixture reaches a viscosity of approximately 25,000 cP. In an embodiment where step i) and step ii) are combined into a single step, blending, stirring or folding of a mucilaginous hydrocolloid, mannan-based hydrocolloid, insoluble fibre, plant derived protein, water, and optionally the texture enhancer may continue until the liquid mixture reaches a viscosity of approximately 25,000 cP.

The liquid mixture may be aerated. Aerating the liquid mixture reduces its specific gravity. Suitably, aerating may reduce the specific gravity of the liquid mixture from between 0.7-0.9 to 0.4-0.6. Although there are various methods by which the liquid mixture may be aerated, merely by way of example, the liquid mixture may be aerated by mixing. A Shufflemixer is an example of a mixer suitable for aerating the liquid mixture.

The combining of the first mixture with the plant derived protein may last any suitable period of time, and may in some embodiments as mentioned above, be a continuous process. In a batch process, combining may continue for a minimum period of time to achieve uniform distribution of the first mixture and plant derived protein whilst avoiding air loss or loss of texture of the liquid mixture obtained. In a batch process, a suitable time period for combination may be between 10 and 60 seconds.

Mixing of two or more ingredients may last any suitable period of time, and may in some embodiments as mentioned above, be a continuous process. In a batch process, mixing may continue for a minimum period of time to achieve uniform distribution of the mucilaginous hydrocolloid, mannan-based hydrocolloid, insoluble fibre, water and plant derived protein in the liquid mixture. In a batch process, a suitable time period for mixing may be between 10 and 600 seconds.

In a suitable embodiment, the liquid mixture may be allowed to rest prior to commencement of step iii) of the method of the second aspect. Resting may occur at any suitable temperature, for example room temperature or refrigerated at a temperature between 2° C. and 20° C. Resting may last up to 1 hour, up to 2 hours, up to 3 hours, up to 4 hours, up to 5 hours, up to 10 hours. In an embodiment, resting may last up to 3 hours.

Applying the liquid mixture to a baking tray may be performed in any suitable way, typically depending upon the desired form of the final food product. For example, liquid mixture may be spread onto a baking tray, in a uniform or non-uniform manner, or may be applied in discrete portions to a baking tray. The term “spreading” as used herein, refers to placing a thin layer of the liquid mixture onto a baking tray. The thickness of the spread liquid mixture may depend upon the desired food product. For example, where the desired food product is a crisp, the layer of liquid mixture may be approximately between 1 mm and 5 mm thick.

Where the desired food product is a pizza base, the layer of liquid mixture may be approximately between 5 mm and 20 mm thick. The portion size of liquid mixture may depend on the desired food product. Merely by way of example, for a biscuit, the portion may be approximately between 20 and 40 ml, while for a pizza base the portion may be between 150 and 500 ml.

The term “baking tray” as used herein, refers to any container or surface on which the food product may be heated. Merely by way of example, a baking tray may be: a baking tin, a baking sheet, or a baking mould. The surface area of the “baking tray” may be lined with a suitable non-stick coating such as Polytetrafluoroethylene (PTFE).

In step iii), the liquid mixture is heated to remove water therefrom, to provide a substantially dehydrated food product or ingredient. Heating may be in the form of baking or dehydration, or indeed any other suitable method. The term “dehydrating” as used herein, refers to gradual removal of water content from the liquid mixture, typically at a low temperature without cooking the ingredients of the liquid mixture. Dehydrating may comprise the removal of moist air, and the replacement with fresh air. Dehydrating may last for any duration from 30 minutes to 12 hours, more suitably for any duration from 30 minutes to 4 hrs, most suitably for any duration from 30 minutes to 2.5 hours. Dehydrating may occur at a temperature between 80° C. and 200° C., suitably between 90° C. and 150° C., more suitably between 135° C. and 140° C. Alternatively, removal of water from the liquid mixture may be achieved by baking, during which the liquid mixture is heated over a shorter period of time at a temperature of between 150° C. and 200° C.

In a suitable embodiment, heating of the liquid mixture may be achieved through the use of a baking oven. Alternatively, heating of the liquid mixture may be achieved through the use of a dehydrator. Other methods suitable for heating or drying the liquid mixture will be known to the skilled person. Any suitable method may be used.

In a suitable embodiment, heating may last until 80%, 85%, 90%, 95% or more of water, has been removed from the liquid mixture. In a suitable embodiment, drying of the liquid may continue until the dehydrated food product of step iii) comprising 15%, 14%, 13%, 12%, 11%, 10%, 9%, 8%, 7%, 6%, 5%, 4%, 3%, 2% or 1% or less of water is formed.

In step iv) of the method of the third aspect of the invention, a dehydrated product may be rehydrated to provide a food product of the first aspect. The step of rehydrating the dehydrated food may increase the weight of the food product as compared to the dehydrated food product. Suitably, the weight of the food product as compared to the dehydrated food product may increase by between 50% and 150%. More suitably, the weight of the food product as compared to the dehydrated food product may increase by approximately 100% upon rehydrating. The dehydrated food product may be rehydrated using water. Suitably, the water may be at a temperature of between 2° C. and 70° C., more suitably at a temperature of between 5° C. and 20° C. In a suitable embodiment, the dehydrated food product may be rehydrated in any suitable way, for example by spraying, brushing, coating, soaking and/or dipping in water. Alternatively or additionally, the dehydrated food product may be rehydrated by incubation in a moist environment.

Flavourings, topping, and enhancers may be added at any suitable step of the process, including for example at one or more of the following stages: in formation of the first mixture; during whisking, if present; during formation of the liquid mixture; after resting of the liquid mixture; immediately prior to heating; after heating; prior to rehydration; after rehydration; or prior to packaging. By “during” is meant immediately prior to, in the process of, or immediately after the referenced step.

The dehydrated or rehydrated product may undergo an optional step of searing. The term “searing” refers to a brief exposure of the rehydrated food product to heat, in order to provide a chargrilled or baked appearance and/or texture. The temperature may be between 140° C.-300° C. Searing may last from a few seconds, up to several minutes. Merely by way of example, searing may be performed by placing the food product on a hotplate, pan, grill, or a barbeque.

Searing may be performed in the presence of a fat. Suitable examples of searing fat include plant and/or animal derived fats. An example of a plant derived fat is olive oil, margarine, sunflower oil and coconut oil. An example of an animal fat is butter. It will be appreciated that any type of edible fat may be used.

As mentioned elsewhere in this specification, the food product of the present invention may be a low fat or substantially fat free food product. It will be appreciated that when the food product of the invention is seared, it is coated with a layer of searing fat but the content of fat in the food product itself remains low or substantially fat free.

The method of the invention may further comprise packaging of the food product or food ingredient, or liquid mixture. The term “packaging” as used herein, refers to placing the food product, ingredient or liquid mixture in a sealable container. Merely by way of example, a sealable container may be a box (for example a plastic or cardboard box), a bag (for example a plastic bag, paper bag or foil bag) or a pouch (for example a plastic pouch or retort pouch), or bottle. Other suitable means for packaging will be known to the skilled person.

In an embodiment, the method of the invention may further comprise a step of sterilising the food product, ingredient, liquid mixture or a meal item, long shelf life product or culinary mix, before packaging or after packaging.

Suitably, the food product or food ingredient may be sterilised in the packaging. Sterilisation may be obtained by any suitable method which will extend the shelf life. By “long shelf life” it is meant that the product will remain fit for consumption, if stored appropriately, for at least 3, 6, 9, 12, 16, 20, 24 months or longer from the date of sterilisation. Appropriate storage includes airtight packaging.

Various methods of food sterilisation will be known to the skilled person. Suitably, the food product or food ingredient of the invention may be sterilised using methods selected from the group consisting of: retort sterilisation, microwave sterilisation, radio wave sterilisation, pasteurisation, and ultra-heat treatment (UHT). Suitably, the food product or food ingredient of the invention is sterilised by retort sterilisation.

It will be appreciated that for sterilisation in the packaging, the packaging must be able to withstand the conditions of the sterilisation process. Thus, for example, for sterilisation by retort, the packaging must be able to withstand heat and pressure of the retort sterilisation process. Suitably, a retort pouch may be used for packaging.

In a further aspect, the invention provides a method of making a food product, the method comprising the steps of:
i) mixing a mucilaginous hydrocolloid, a mannan-based hydrocolloid, insoluble fibre, plant derived protein and water to provide a liquid mixture;
ii) optionally, applying the liquid mixture onto a baking sheet;
iii) heating the liquid mixture to remove water and provide a substantially dehydrated food product;
iv) optionally re-hydrating the dehydrated food product of iii)
v) optionally forming the food product into shapes; and

vi) sterilising the food product.

A method comprising the step of sterilising the food product, gives rise to the sixth aspect of the invention which relates to a long shelf life food product comprising a mucilaginous hydrocolloid, a mannan-based hydrocolloid, plant derived protein, insoluble fibre, and optionally water. It will be appreciated that if the long shelf life food product does not comprise water, it is a dehydrated food product of the fourth aspect of the invention which has been sterilised. By the same token, if the long shelf life food product comprises water, it is a food product of the first aspect of the invention which has been sterilised.

In an embodiment, the method further comprises the step of grinding the rehydrated or dehydrated product, to form a food ingredient of the second aspect. Suitably, the product is not rehydrated prior to grinding. The term “grinding” refers to a process of converting a product, such as a food product produced in steps i) to iv), into a population of small particles or grains. Grinding typically involves pulverising a food product by abrasion or friction to produce a food ingredient with a granular appearance. The term “grinding” may also include processes such as a milling, blending, pulverising, breaking, mincing, grating, shredding or crumbling.

In a method of the third aspect of the invention, the substantially dehydrated food product or ingredient may be rehydrated. The optional step of rehydrating the substantially dehydrated food product or ingredient may increase the weight of the food product or ingredient as compared to the substantially dehydrated version. Suitably, the weight of the re-hydrated food product or ingredient as compared to the substantially dehydrated food product or ingredient may increase by between 50% and 150%. More suitably, the weight of the rehydrated food product or ingredient as compared to the substantially dehydrated food product or ingredient may increase by approximately 100% upon rehydrating. The substantially dehydrated food product or ingredient may be rehydrated using water. Suitably, the water may be at a temperature of between 2° C. and 70° C., more suitably at a temperature of between 5° C. and 20° C. In a suitable embodiment, the substantially dehydrated food product or ingredient may be rehydrated in any suitable way, for example by spraying, brushing, coating, soaking and/or dipping in water. Alternatively, or additionally, the substantially dehydrated food product or ingredient may be rehydrated by incubation in a moist environment.

### Liquid Mixture

In a fourth aspect, the present invention provides a liquid mixture which may be used to produce a food product or ingredient of the invention. When the liquid mixture is heated to remove the water content, a dehydrated food product or ingredient may be obtained. When a dehydrated food product or ingredient is subsequently rehydrated, a food product or ingredient of the first aspect may be obtained.

By “low carbohydrate” it is meant that the liquid mixture has a carbohydrate content of about 10, 9, 8, 7, 6, 5, 4, 3, 2, 1, 0.5, 0.4, 0.3, 0.2 or 0.1 or less gram(s) per 100 grams. Suitably, the dehydrated food product or ingredient has a carbohydrate content of about 1 to 3 grams per 100 grams. Suitably, the food ingredient does not comprise carbohydrate from any source other than the mucilaginous hydrocolloid and mannan-based hydrocolloids.

The liquid mixture of the invention may be a low-calorie product. A calorie as used herein is an approximate amount of energy needed to raise the temperature of one gram of water by one degree Celsius at a pressure of one atmosphere. By “low calorie” it is meant that the dehydrated food product or ingredient may have a calorie content of 50, 45, 40, 35, 30, 25, 20, 15, 10, 5 or less per 100 grams.

The liquid mixture of the invention may be a low fat product. By “low fat” it is meant that the liquid mixture has a fat content of less than 5, 4, 3, 2.8, 2.6, 2.4, 2.2, 2, 1.8, 1.6, 1.4, 1.2, 1, 0.8, 0.6, 0.4, or 0.2 grams of fat per 100 grams. In other terms, it can be said the liquid mixture of the invention comprises 5%, 4% 3%, 2.8%, 2.6%, 2.4%, 2.2%, 2%, 1.8%, 1.6%, 1.4%, 1.2%, 1%, 0.8%, 0.6%, 0.4%, or 0.2% or less by weight of fat. Suitably, the dehydrated food product or ingredient of the invention may be substantially fat free. By “substantially fat free” it is meant that the fat content of the liquid mixture of the invention is 1 g or less per 100 grams, i.e. it comprises about 1% or less weight of fat. The term “fat” refers to triglyceride molecules naturally found within the ingredients described herein.

The liquid mixture of the invention may be a high fibre product. By “high fibre” it is meant that the liquid mixture has a fibre content of about 10, 9, 8, 7, 6, 5, 4, 3, 2, 1 grams of fibre per 100 grams of fibre per 100 grams. It will be appreciated the fibre content may be derived not only from the insoluble fibre, but also from the mucilaginous hydrocolloid (such as psyllium), the mannan-based hydrocolloid (for example konjac), and/or a texture enhancer (for example hydroxypropylmethylcellulose), if such a texture enhancer is present.

In the liquid mixture, this is based on a plant derived protein being reconstituted in water at a concentration of 12.5% of plant derived protein and 87.5% of water. However, the skilled person will appreciate that if these concentrations are altered, the amount of water used to make liquid mixture may require adjustment accordingly to yield a food ingredient having the proportions defined herein. For example, if the liquid comprising a plant derived protein comprises more than 12.5% protein powder, the amount of water to make the liquid mixture may be proportionally increased. By the same token, if the liquid comprising a plant derived protein comprises less than 12.5% protein powder, the amount of water to make the liquid mixture may be proportionally decreased.

A liquid mixture according to the third aspect of the invention may comprise at least 0.1%, 0.2%, 0.3%, 0.35%, 0.5%, 1%, 2%, 3%, 4%, 5%, 6%, 7%, 8%, 9%, at least 10% by weight, of a mucilaginous hydrocolloid. Suitably, the liquid mixture may comprise at least 0.3% by weight of a mucilaginous hydrocolloid, suitably between 0.3% and 1% by weight of a mucilaginous hydrocolloid. Suitably, the liquid mixture may comprise approximately 0.5% by weight of a mucilaginous hydrocolloid. Suitably the mucilaginous hydrocolloid is psyllium.

A liquid mixture according to the third aspect of the invention may comprise at least 0.1%, 0.2%, 0.3%, 0.35%, 0.5%, 1%, 2%, 3%, 4%, 5%, 6%, 7%, 8%, 9%, at least 10% by weight, of a mannan-based hydrocolloid. Suitably, the liquid mixture may comprise at least 0.3% by weight of a mannan-based hydrocolloid, suitably between 0.3% and 1% by weight of a mannan-based hydrocolloid. Suitably, the liquid mixture may comprise approximately 0.5% by weight of a mannan-based hydrocolloid. Suitably, the mannan-based hydrocolloid is konjac.

The liquid mixture according to the fourth aspect of the invention may comprise at least 0.5%, 1%, 2%, 3%, 4%, 5%, 6%, 7%, 8%, 9%, 10%, 11%, 12%, 13%, 14%, 15%, 16%, 17%, 18%, 19%, or 20% by weight of plant derived protein. Suitably, the liquid mixture may comprise from 0.5 to 5% by weight of plant derived protein. Suitably the liquid mixture may comprise from 1% to 3% by weight of plant derived protein. Suitably, the liquid mixture may comprise approximately 2% by weight of plant derived protein. Suitably, the plant derived protein is a legume protein, suitably selected from the group consisting of pea protein, mung bean protein, soy bean protein and chickpea protein, or any combination of two or more thereof.

The liquid mixture according to the third aspect of the invention may comprise at least 1% 2%, 2.5%, 3%, 3.5%, 4%, 4.5%, 5%, 6%, 7%, 8%, 9%, or 10% by weight of insoluble fibre. Suitably, the liquid mixture may comprise from 1 to 6% by weight of insoluble fibre. Suitably, the liquid mixture may comprise approximately 4% by weight of insoluble fibre. Suitably, the insoluble fibre is wheat fibre.

The liquid mixture of the fourth aspect of the invention may comprise at least 50%, 55%, 60%, 70%, 75%, 80%, 85%, or at least 90% by weight of water. Suitably, the liquid mixture of the third aspect may comprise 70% to 90% of water. Suitably, the liquid mixture of the third aspect comprises approximately 90% by weight of water.

The liquid mixture according to the third aspect of the invention may optionally comprise at least 0.1%, 0.2%, 0.3%, 0.4%, 0.5%, 1%, 1.5%, 2%, 2.5%, 3%, 3.5%, 4%, 4.5%, or 5% by weight of a texture enhancer. Suitably, the liquid mixture comprises 1% to 3% by weight of a texture enhancer. Suitably, the liquid mixture comprises approximately 1-1.5% by weight of a texture enhancer. Suitably, the texture enhancer is HPMC.

In an embodiment, the liquid mixture may comprise between 0.1% and 10% by weight of a mucilaginous hydrocolloid, 0.1% and 10% by weight of a mannan-based hydrocolloid, between 1% and 20% by weight of plant derived protein, between 1% and 10% by weight of insoluble fibre, and between 50% and 90% of water, and optionally between 0.1% and 5% by weight of a texture enhancer. Suitably the mucilaginous hydrocolloid is psyllium. Suitably the mannan-based hydrocolloid is konjac. Suitably the insoluble fibre is wheat fibre. Suitably the texture enhancer is HPMC. Suitably, the plant derived protein is a legume protein, suitably selected from the group consisting of pea protein, mung bean protein, soy bean protein and chickpea protein, or any combination of two or more thereof.

Suitably, the liquid mixture may comprise between 0.3% and 1% by weight of a mucilaginous hydrocolloid, 0.3% and 1% by weight of a mannan-based hydrocolloid, between 0.5% and 5% by weight of plant derived protein, between 1% and 6% by weight of insoluble fibre, and between 70% and 75% of water, and optionally between 1% and 2% by weight of a texture enhancer. Suitably the mucilaginous hydrocolloid is psyllium. Suitably the mannan-based hydrocolloid is konjac. Suitably the insoluble fibre is wheat fibre. Suitably the texture enhancer is HPMC.

Suitably, the liquid mixture may comprise 0.3% to 1% by weight of a mucilaginous hydrocolloid, 0.3% to 1% by weight of a mannan-based hydrocolloid, 1% to 3% by weight of plant derived protein, 1% to 6% by weight of insoluble fibre, and from 75% to 90% of water, and optionally 1% to 2% by weight of a texture enhancer. Suitably the mucilaginous hydrocolloid is psyllium. Suitably the mannan-based hydrocolloid is konjac. Suitably the insoluble fibre is wheat fibre. Suitably the texture enhancer is HPMC.

In a most suitable embodiment, the liquid mixture may comprise approximately 0.5% by weight of a mucilaginous hydrocolloid, approximately 0.5% by weight of a mannan-based hydrocolloid, approximately 2% by weight of plant derived protein, approximately 4% by weight of insoluble fibre, and approximately 90% of water, and optionally approximately 1.5% by weight of a texture enhancer. Suitably the mucilaginous hydrocolloid is psyllium. Suitably the mannan-based hydrocolloid is konjac. Suitably the insoluble fibre is wheat fibre. Suitably the texture enhancer is HPMC. Suitably, the plant derived protein is a legume protein, suitably selected from the group consisting of pea protein, mung bean protein, soy bean protein and chickpea protein, or any combination of two or more thereof.

In an embodiment, the amount of a mucilaginous hydrocolloid, a mannan-based hydrocolloid, plant derived protein, insoluble fibre and water, and optionally a texture enhancer in the liquid mixture may be adjusted within the afore-mentioned ranges so as to provide a food product or ingredient where in total these ingredients account for at least 90% of the food product or ingredient.

In an embodiment, the amount of a mucilaginous hydrocolloid, a mannan-based hydrocolloid, plant derived protein, insoluble fibre, and water, and optionally a texture enhancer may be adjusted within the afore-mentioned ranges so as to provide a dehydrated food product of the invention, where the mucilaginous hydrocolloid, the mannan-based hydrocolloid, plant based protein, insoluble fibre, and optionally texture enhancer account for at least 90% of the dehydrated food product.

In an embodiment, the amount of the mucilaginous hydrocolloid, the mannan-based hydrocolloid, plant based protein, insoluble fibre, and water, and optionally texture enhancer may be adjusted within the afore-mentioned ranges so that in total these ingredients account for approximately 90-100% of the liquid mixture.

In a suitable embodiment, the plant derived protein in a liquid mixture of the fourth aspect may be derived from pea or bean. In a most suitable embodiment, the mucilaginous hydrocolloid is psyllium, the mannan-based hydrocolloid is konjac, the insoluble fibre is wheat fibre, and the plant derived protein is pea or bean protein, mushroom or potato skin. More suitably, the plant derived protein may be chickpea protein isolate or pea isolate, soybean isolate, or mung bean protein isolate, or a combination of two or more thereof, for example soy bean protein and pea protein.

As touched upon elsewhere in the specification, the liquid mixture of the fourth aspect of the invention may be used to produce a dehydrated food product or dehydrated ingredient according to a fifth aspect of the invention. Such a dehydrated food product or dehydrated ingredient comprises a mucilaginous hydrocolloid, a mannan-based hydrocolloid, plant derived protein, insoluble fibre, and optionally a texture enhancer, and suitably is as described herein.

### Dehydrated Food Product

The term “dehydrated” refers to a food product or ingredient which is a substitute for a food product or ingredient conventionally made from a grain or flour which substantially does not comprise water. By substantially is meant that it is either completely dehydrated so that the water content is zero, or that it contains a residual water content after baking. The residual water content may be, or may be less than, 10%, or more suitably may be or may be less than 7%, 5%, 4%, 3% 2% or 1%. Such a food product may be a substitute for a dried food product conventionally made from a dough or batter. Therefore, a dehydrated food product of the present invention may be similar, or substantially the same, in terms of texture and/or taste to a conventional dried food product made from a grain or flour, or derived from dough or batter. Such conventional food products may include, without limitation, a cracker, a portion of crisps, a portion of noodles, a portion of dried pasta, a portion of dried cereal, a cereal bar, a portion of dried porridge, or a portion of dried muesli. Therefore, a dehydrated food product of the invention may include a cracker, crisp, biscuit, noodle, pasta, cereal, cereal bar, porridge, or muesli, or a portion of any such item.

By “low carbohydrate” it is meant that the dehydrated food product or ingredient has a carbohydrate content of about 20, 19, 18, 17, 16, 15, 14, 13, 12, 11, 10, 9, 8, 7, 6, 5, 4, 3, 2, or 1 gram(s) or less per 100 grams. Suitably, the dehydrated food product or ingredient has a carbohydrate content of about 10 to 20 gram per 100 grams. Suitably, the food ingredient does not comprise carbohydrate from any source other than the mucilaginous hydrocolloid and mannan-based hydrocolloids. Suitably, when a dehydrated food product or ingredient of the invention is a bakery food product, ingredient or liquid mixture, it may have a carbohydrate content of 0.3 grams or less per 100 grams.

The dehydrated food product or ingredient of the invention may be a low-calorie product. A calorie as used herein is an approximate amount of energy needed to raise the temperature of one gram of water by one degree Celsius at a pressure of one atmosphere. By “low calorie” it is meant that the dehydrated food product or ingredient may have a calorie content of 350, 300, 250, 150, 100, 90, 80, 70, 60, or 50 kcal or less per 100 grams. Suitably, the dehydrated food product or ingredient may have a calorie content of about 300 kcal per 100 grams or less.

The dehydrated food product or ingredient of the invention may be a low fat product. By “low fat” it is meant that the dehydrated food product or ingredient has a fat content of less than 3, 2.8, 2.6, 2.4, 2.2, 2, 1.8, 1.6, 1.4, 1.2, 1, 0.8, 0.6, 0.4, or 0.2 grams of fat per 100 grams. In other terms, it can be said the food product, ingredient or liquid mixture of the invention comprises less than 3%, 2.8%, 2.6%, 2.4%, 2.2%, 2%, 1.8%, 1.6%, 1.4%, 1.2%, 1%, 0.8%, 0.6%, 0.4%, or 0.2% by weight of fat. Suitably, the dehydrated food product or ingredient of the invention may be substantially fat free. By “substantially fat free” it is meant that the fat content of the dehydrated food product or ingredient of the invention is 1 g or less per 100 grams, i.e. it comprises about 1% or less weight of fat. The term “fat” refers to triglyceride molecules naturally found within the ingredients described herein.

The dehydrated food product or ingredient of the invention may be a high fibre product. By “high fibre” it is meant that the dehydrated food product or ingredient has a fibre content of 30, 40, 45, 50, 55, 60 or more grams of fibre per 100 grams of fibre per 100 grams. It will be appreciated the fibre content may be derived not only from the insoluble fibre, but also from the mucilaginous hydrocolloid (such as psyllium), the mannan-based hydrocolloid (for example konjac), and/or a texture enhancer (for example hydroxypropylmethylcellulose), if such a texture enhancer is present.

A dehydrated food product or dehydrated ingredient of the fifth aspect of the invention may comprise at least 1%, 1.5%, 2%, 2.5%, 3%, 3.5%, 4%, 4.5%, 5%, 6%, 7%, 8%, 9%, 10%, 11%, 12%, 13%, 14%, 15%, 20%, or at least 25% by weight of a mucilaginous hydrocolloid. Suitably, the dehydrated food product or dehydrated ingredient may comprise 2 to 10% by weight, suitably 3% to 7% by weight of a mucilaginous hydrocolloid, most suitably approximately 5% by weight of a mucilaginous hydrocolloid. Suitably the mucilaginous hydrocolloid is psyllium.

A dehydrated food product or dehydrated ingredient of the fifth aspect of the invention may comprise at least 1%, 1.5%, 2%, 2.5%, 3%, 3.5%, 4%, 4.5%, 5%, 6%, 7%, 8%, 9%, 10%, 11%, 12%, 13%, 14%, 15%, 20%, or at least 25% by weight of a mannan-based hydrocolloid. Suitably, the dehydrated food product or dehydrated ingredient may comprise 2 to 10% by weight, suitably 3% to 7% by weight of a mannan-based hydrocolloid, most suitably approximately 5% by weight of a mannan-based hydrocolloid. Suitably the mannan-based hydrocolloid is konjac.

A dehydrated food product or dehydrated ingredient of the fifth aspect of the invention may comprise at least 5%, 6%, 7%, 8%, 9%, 10%, 11%, 12%, 13%, 14%, 15%, 16%, 17%, 18%, 19%, 20%, 21%, 22%, 23%, 24%, 25%, 30%, 32%, 35%, 40%, 45%, or at least 50% by weight, of plant derived protein. Suitably, the dehydrated food or dehydrated ingredient may comprise 10 to 40% by weight of plant derived protein, suitably 15% to 40% by weight of plant derived protein. Suitably, the dehydrated food may comprise 15 to 30% by weight, of plant derived protein, suitably 15% to 25% by weight of plant derived protein. Suitably, the dehydrated food product or dehydrated ingredient of the fifth aspect of the invention may comprise approximately 19-23% plant derived protein. Suitably, the plant based protein may be a legume protein, suitably selected from the group consisting of pea protein, soy bean protein, chickpea protein or mung bean protein, or any combination of two or more thereof. For example, a combination of pea protein with one or more of soy bean protein, mung bean protein or chickpea protein may be suitable.

A dehydrated food product or dehydrated ingredient of the fifth aspect of the invention may comprise 20, 25%, 30%, 35%, 40%, 45%, 50%, 55%, or 60% by weight, of insoluble fibre. Suitably, the dehydrated food product or dehydrated ingredient may comprise at least 20% by weight, of insoluble fibre, suitably between 40% and 60% by weight, of insoluble fibre. Suitably, the dehydrated food product or dehydrated ingredient may comprise approximately 50% by weight, of insoluble fibre. Suitably the insoluble fibre is wheat fibre.

A dehydrated food product or dehydrated ingredient of the fifth aspect of the invention may comprise at least 5%, 10%, 11%, 12%, 13%, 14%, 15%, 16%, 17%, 18%, 19%, 20%, 25%, or 30% by weight, of a texture enhancer. Suitably, the dehydrated food product or dehydrated ingredient may comprise at least 10% by weight, of a texture enhancer, suitably 10% to 20% by weight of a texture enhancer. Suitably, the dehydrated food product or dehydrated ingredient may comprise approximately 12% by weight of a texture enhancer. Suitably the texture enhancer is HPMC.

A dehydrated food product or dehydrated ingredient of the fifth aspect of the invention may comprise 20%, 15%, 14%, 13%, 12%, 11%, 10%, 9%, 8%, 7%, 6%, 5%, 4%, 3%, 2%, 1%, 0.5% or less, or 0.1% or less by weight of water. Suitably, the dehydrated food product or dehydrated ingredient may comprise 5% or less by weight of water.

Suitably, a dehydrated food product or ingredient of the invention may comprise 2% and 10% by weight of a mucilaginous hydrocolloid, from 2% to 10% by weight of a mannan-based hydrocolloid, from 25% to 60% by weight of insoluble fibre, from 10 to 40% by weight of plant derived protein, and from 0% to 10% of water, and optionally from 10% to 20% by weight of a texture enhancer. Suitably, the mucilaginous hydrocolloid may be psyllium. Suitably, the mannan based hydrocolloid may be konjac. Suitably, the plant based protein may be a legume protein, suitably selected from the group consisting of pea protein, soy bean protein, chickpea protein or mung bean protein, or any combination of two or more thereof. Suitably, the plant based protein is a pea protein.

Suitably, a dehydrated food product or ingredient of the invention may comprise 2% and 10% by weight of a mucilaginous hydrocolloid, from 2% to 10% by weight of a mannan-based hydrocolloid, from 20% to 60% by weight of insoluble fibre, from 15 to 25% by weight of plant derived protein, and from 0% to 10% of water, and optionally from 10% to 20% by weight of a texture enhancer. Suitably, the mucilaginous hydrocolloid may be psyllium. Suitably, the mannan based hydrocolloid may be konjac. Suitably, the plant based protein may be a legume protein, suitably selected from the group consisting of pea protein, soy bean protein, chickpea protein or mung bean protein, or any combination of two or more thereof. Suitably, the plant based protein is a pea protein.

Suitably, dehydrated food product or ingredient of the invention may comprise between 3% and 7% by weight of a mucilaginous hydrocolloid, between 3% and 7% by weight of a mannan-based hydrocolloid, between 20% and 60% by weight of insoluble fibre, between 15% and 25% by weight of plant derived protein, between 0% and 5% of water, and optionally between 10% and 20% by weight of a texture enhancer. Suitably, the mucaliginous hydrocolloid may be psyllium. Suitably, the mannan based hydrocolloid may be konjac. Suitably, the plant based protein may be a legume protein, suitably selected from the group consisting of pea protein, soy bean protein, chickpea protein or mung bean protein, or any combination of two or more thereof.

More suitably, a dehydrated food product or ingredient of the invention may comprise from 3% to 7% by weight of a mucilaginous hydrocolloid, from 3% to 7% by weight of a mannan-based hydrocolloid, between 40% and 60% by weight of insoluble fibre, from 15% to 25% by weight of plant derived protein, from 0% to 5% of water, and optionally from 12% to 17% by weight of a texture enhancer. Suitably, the mucilaginous hydrocolloid may be psyllium. Suitably, the mannan based hydrocolloid may be konjac. Suitably, the plant based protein may be a legume protein, suitably selected from the group consisting of pea protein, soy bean protein, chickpea protein or mung bean protein, or any combination of two or more thereof.

In a suitable embodiment, a dehydrated food product or ingredient of the invention may comprise approximately 5% by weight of a mucilaginous hydrocolloid, approximately 5% by weight of a mannan-based hydrocolloid, approximately 50% by weight of insoluble fibre, approximately 23% by weight of plant derived protein, approximately 1% by weight of water, and optionally approximately 15% by weight of a texture enhancer. Suitably, the mucilaginous hydrocolloid may be psyllium. Suitably, the mannan based hydrocolloid may be konjac. Suitably, the plant based protein may be a legume protein, suitably selected from the group consisting of pea protein, soy bean protein, chickpea protein or mung bean protein, or any combination of two or more thereof. Suitably, the plant based protein is a pea protein.

### Meal Item

In the context of the sixth aspect the term “meal item” refers to a food which comprises a food product of the first or fifth aspect of the invention, in addition to a topping, filling, dressing, sauce, and/or spread. A suitable topping or filling may be, for example, selected from the group consisting of: dairy (such as cheese), eggs, meat (for example ham), fish, vegetables, fruits, herbs, and spices. A suitable dressing or sauce may be, for example, selected from the group consisting of passata (tomato sauce), ketchup, mayonnaise, mustard, olive oil, balsamic vinegar, caeser dressing, French dressing, honey, maple syrup, agave syrup, and fruit compote. A suitable spread may be selected from the group consisting of: cream cheese, chocolate spread, peanut butter, marmite, butter, and jam.

It will be the appreciated that the percentages mentioned throughout this specification refer to the food products themselves, i.e. the food product, food ingredient, liquid mixture, or the dehydrated food product or ingredient of the invention. The percentages do not include any toppings, fillings, dressings, spreads, which may be added to the food products of the invention to provide a meal item.

Merely by way of example, a meal item comprising a bakery food product of the first aspect of the invention may be selected from the group consisting of: a pizza, a wrap sandwich, a quesadilla, a sandwich, a burrito, a chimichanga, and a Mexican lasagne. Other suitable meal items will be known to the skilled person. Merely by way of example, a meal item comprising a dehydrated food product of the fourth aspect of the invention may be tacos or tortilla chips.

### Culinary Mix

The term “culinary mix” refers to two or more ingredients for making a food, wherein one or more of the ingredients is a food ingredient of the invention. The culinary mix may comprise other food ingredients, such as sugar, cocoa, flavouring, colouring, fats, baking powder, salt or egg. A culinary mix of the invention may comprise two or more food ingredients in a single pack. A culinary mix may comprise two or more food ingredients in separate packaging. A culinary mix may comprise all of the ingredients or some of the ingredients required to make a food. Suitably, a culinary mix may be added to staple food products, such as milk, butter, oil to make a food product. Suitably, a culinary mix of the present invention may be used to make a food such as bread or bread crumbs, coatings, batters, cakes, brownies, pancakes, waffles or pastries. A culinary mix may also comprise toppings, fillings, coatings, and/or decorations. The present invention also provides a kit comprising a culinary mix of the present invention and one or more non-edible components such as an instructions leaflet, a cup cake case, a spatula, measuring spoon, or non-edible decorations.

In an eighth aspect, the present invention provides a culinary mix comprising two or more ingredients for making a food, wherein one or more of the ingredients is a food ingredient of the invention. A culinary mix may comprise other food ingredients, such as sugar, artificial sweetener, cocoa, flavouring, colouring, fats, baking powder, salt or egg.

In a suitable embodiment a culinary mix of the seventh aspect of the invention may provide ingredients required to make a brownie. Suitably, such a culinary mix may comprise up to 10%, 20%, 30%, 40%, 50%, 60%, 70% or 80% of a granular food ingredient of the invention.

In a suitable embodiment, a culinary mix of the present invention comprises a food ingredient of the invention, a sweetener, a binding agent and wheat. The food ingredient of the invention may suitably be a fine crumb or a flour.

Suitably, the culinary mix may comprise about 50-60% sweetener, 30-45% fine crumb or flour, 15-25% binding agent, and 3-10% wheat.

Suitably in such culinary mix may also comprise flavourings, a gelling agent, preservatives, colourings. These ingredients may be 10% or less of the culinary mix.

Suitably, the culinary mix is for preparing a brownie or a cake, and comprises: sweetener at about 50-60%; flour or crumb of the first, second or third aspect at 18-23%, binding agent at 8-12%, wheat at 4-8%, flavourings at 4-8%, and colour, preservatives and gelling agents etc in suitable amounts.

### Food Enhancers

A food product of the first aspect, an ingredient a liquid mixture of third aspect, and/or the dehydrated food product of the fourth aspect of the invention may comprise a food enhancer. Suitably, the food products and/or liquid mixture of the invention may comprise less than 10%, 9%, 8%, 7%, 6%, 5%, 4%, 3%, 2%, or less than 1% by weight, of a food enhancer.

Suitable food enhancers may enhance the taste, mouthfeel, appearance and/or longevity of the food product. In one embodiment, an enhancer may enhance one or more of these.

For example, food enhancers that enhance the taste of the food product may be selected from the group consisting of: food acids (for example citric acid), natural flavour (for example salt, pepper, and garlic powder), artificial flavours (for example monosodium glutamate, potassium bromate, potassium sorbate, and vanillan), condiments (for example salt and paper) and sweeteners (for example stevia, agave syrup, aspartame, high-fructose corn syrup, saccharin, sucralose and sugar alcohol, or any combination thereof. Other suitable food enhancers that enhance the taste of the food products will be known by the skilled person.

Food enhancers that enhance the mouthfeel of the food products, may be selected from the group consisting: emulsifiers (for example oils and fat), humectants (for example sorbitol, glycerol, and propylene glycol), or a combination thereof. Other food enhancers that enhance the mouthfeel of the food products will be apparent to the skilled person.

Food enhancers that enhance the appearance of the food product may be selected from the group consisting of: food colouring (for example artificial and natural food dyes), colour retention agents (for example ascorbic acid) and glazing agents (for example propylene glycol, eggin, dimethylpolysiloxane, beeswax, candelilla wax and carnauba wax), or any combination thereof. Other food enhancers that enhance the appearance of the food products will be apparent to the skilled person.

Food enhancers that enhance the longevity of the food product of the invention may be selected from the group consisting of: stabilizers (for example alginic acid, gelatin and lecithin), preservatives (for example propionic acid and sodium propionate) and antioxidants (for example ascorbic acid, butylated hydroxytoluene, and butylated hydroxyanisole), or any combination thereof. Other food enhancers that enhance the longevity of the food products will also be apparent to the skilled person.

Suitably, the food product or ingredient of the invention may comprise less than 2%, or less than 1% by weight of a food enhancer. Suitably, the food enhancer is a taste enhancer, suitably the taste enhancer is salt.

Suitably, the dehydrated food product or dehydrated ingredient of the invention may comprise less than 5% by weight of a food enhancer. Suitably, the food enhancer is a taste enhancer, suitably the taste enhancer is salt.

It will be appreciated that the food product or ingredients, and the liquid mixture may comprise other suitable ingredients. When the food product, ingredient and/or the liquid mixture of the invention comprises other such ingredients, the skilled person will be able to adjust the abovementioned proportions (for example based on the ranges of suitable proportions disclosed elsewhere within this specification) to obtain a food product, ingredient or liquid mixture of the invention.

### Packaging

The term “packaged” in the context of the present invention refers to a food ingredient of the present invention that is provided in packaging. Packaging may include primary packaging, referring to the layer of packaging in immediate contact with the food ingredient or culinary mix of the invention. Packaging may also include secondary or tertiary packaging, referring to additionally packaging in which primary packaging is contained. The food ingredients of the present invention may be provided in a range of portion sizes. Suitably, the food ingredient of the present invention may be provided in portion sizes that is suitable for consumer use, commercial scale use, and/or manufacturing scale use. Suitably, the culinary mix of the second aspect of the invention may be provided in one or more packs. Suitably, a food ingredient or culinary mix of the present invention may be sterilised whilst in its packaging. Suitably, a food ingredient or culinary mix of the present invention may be sterilised before it is packaged. Suitably, a portion sized packaging may comprise a granular food ingredient of the first aspect of invention in a quantity that is sufficient to make at least one serving of food. Suitably, a portion sized packaging may comprise a granular food ingredient of the first aspect of invention in a quantity that is sufficient to make at least one serving of coating or filling. Suitably, the size of a portion size pack may depend on the desired product. Suitably, a portion sized pack of a granular food ingredient of the first aspect of the invention may be between 50 g to 1 kg in weight. Suitably, a portion sized pack of a culinary mix of the second aspect of the invention may be between 50 g to 1 kg in weight. Merely by way of example, a portion sized pack of a culinary mix suitable to make brownies and/or cake may be approximately between 50 and 100 g, approximately between 100 and 200 g, approximately between 200 g and 300 g, approximately between 300 g and 400 g, approximately between 400 g and 500 g, approximately between 500 g and 600 g, approximately between 600 g and 700 g, approximately between 700 g and 800 g, approximately between 800 g and 900 g, approximately between 900 g and 1000 g.

It will be the appreciated that the percentages mentioned throughout this specification refer to the food products themselves, i.e. the food product, food ingredient, liquid mixture, or the dehydrated food product or ingredient of the invention. The percentages do not include any toppings, fillings, dressings, spreads, which may be added to the food products of the invention to provide a meal item.

Merely by way of example, a meal item comprising a bakery food product of the first aspect of the invention may be selected from the group consisting of: a pizza, a wrap sandwich, a quesadilla, a sandwich, a burrito, a chimichanga, and a Mexican lasagne. Other suitable meal items will be known to the skilled person. Merely by way of example, a meal item comprising a dehydrated food product of the fourth aspect of the invention may be tacos or tortilla chips.

The invention is not restricted to the details of any forgoing embodiments. The embodiments of each aspect apply to the other aspects of the invention, mutatis mutandis. Therefore, any one or more ingredients or amounts of ingredients may be combined with any one or more other ingredients or amounts of ingredients, defined in the same or another aspect.

Throughout the description and claims of this specification, the words “comprise” and “contain” and variations of them mean “including but not limited to”, and they are not intended to (and do not) exclude other components. Throughout the description and claims of this specification, the singular encompasses the plural unless the context otherwise requires. In particular, where the indefinite article is used, the specification is to be understood as contemplating plurality as well as singularity, unless the context requires otherwise. Also included within the scope of the invention are food products, ingredients, dehydrated food products and ingredients, liquid mixes, and culinary mixes consisting of or consisting essentially of the constituents as described herein.

Features described in conjunction with a particular embodiment of the invention are to be understood to be applicable to any other embodiment described herein unless incompatible therewith. All of the features disclosed in this specification (including any accompanying claims and drawings) may be combined in any combination, except combinations where at least some of such features and/or steps are mutually exclusive. The invention extends to any novel one, or any novel combination, of the features disclosed in this specification (including any accompanying claims).

Where ranges are provided, the present invention includes the endpoints of each range, and any range between any two values provided in the range. Ranges defined as “between” also include the endpoints of the range. Where a value is defined as “at least” or “more than” or “less than”, it is understood to also include the value of the integer. The values expressed herein are also approximate, and include a 10% margin either side of the value or endpoints of a range.

### EXAMPLES

### Example 1 A Rehydrated Food Product

For a rehydrated food product (such as a pizza base), a liquid mixture of 762 grams was prepared using the following ingredients:
Psyllium—4 grams (accounting for ˜0.5% of the liquid mixture),
Konjac—4 grams (accounting for ˜0.5% of the liquid mixture),
Pea Protein—20 grams
Wheat fibre—22 grams (accounting for ˜4% of the liquid mixture),
Water—700 grams (accounting for ˜80% of the liquid mixture),
Hydroxypropyl methylcellulose (HPMC)—10 grams (accounting for 1.5% of the liquid mixture), and optionally
Salt—2 grams (accounting for ˜0.5% of the liquid mixture)

Psyllium, konjac, wheat fibre, HPMC, pea protein isolate, salt and water were mixed under high dispersal conditions until the mixture reached a viscosity of approximately 40,000 cP. Blending continued until a uniform blended mixture with a viscosity of 25,000 cP was obtained.

The blended mix was allowed to rest for 5 minutes at room temperature before 202 g was transferred to a 22 cm diameter PTFE coated pan and dehydrated in an oven at a temperature of 110° C. for 2.5 to 3.5 hours. The dehydration process removed approximately 95% of the water initially found in the liquid mixture. The 16 g dehydrated disc was then rehydrated by submerging it in water. It absorbed approximately 12 g, providing a final product weight of 28 g.

A pizza base made as outlined above weighs approximately 28 grams and has the following nutritional values (per 28 grams):

41 kcal; 2.5 grams of carbohydrates (of which zero sugars); 9 grams of fibre; 7 grams of protein; 0.2 grams of fat and no gluten

Upon rehydration the food product was packaged in a retort pouch and sterilised in a retort machine. The sterilisation process was carried out at a temperature of approximately 121° C. and a pressure of approximately 1.8 bar. The sterilisation process under these pressure conditions may last for approximately 3 to 20 minutes.

### Example 2 Pea Protein

This recipe makes 8 pieces

Konjac 7.7 g

Psyllium 7.7 g

HPMC 21.4 g

Pea Protein Isolate (85% protein) 32 g

Salt 4.2 g

Wheat Fibre 68.2 g

Water 1467 ml

Deposit size: 201 g

Dry disc weight: 17 g

Finished disc weight: 34 g

Bake time: 3 hrs at 120C

### Example 3 Soya Protein

This recipe makes 8 pieces

### Konjac 7.7 g

### Psyllium 7.7 g

### HPMC 21.4 g

Soya Protein Isolate (90% protein) 26.6 g

### Salt 4.2 g

### Wheat Fibre 68.2 g

### Water 1467 ml

Deposit size: 200 g
Dry disc weight: 17 g
Finished disc weight: 34 g
Bake time: 3 hrs at 120C

### Example 4 Pea and Faba Bean Protein

This recipe makes 8 pieces

| | |
|---|---|
| Konjac | 7.7 g |
| Psyllium | 7.7 g |
| HPMC | 21.4 g |
| Faba Bean Protein Isolate (88% protein) | 16 g |
| Pea Protein Isolate (85% protein) | 16 g |
| Salt | 4.2 g |
| Wheat Fibre | 68.2 g |
| Water | 1467 ml |

Deposit size: 201 g
Dry disc weight: 17 g
Finished disc weight: 34 g
Bake time: 3 hrs at 120C

Texture Profile Testing, a Tortilla Burst Test and an Extrusion Test are used to test the baked products of the invention and compare to available products such as commercially available tortillas and white bread.

An extrusion test measures the amount of force required to extrude a piece of a sample, for example after hydration. This test provides an indication of water absorbancy and structural integrity compared to available bread products.

Texture Analyser Test is used to measure the “bounce back” or springiness of the product after a load is applied. A Tortilla Burst Test is also used.

An elasticity test is used to measure the integrity of the product after folding. Elasticity was tested by determining if the product is able to be completely folded in half and lightly pressed together such that the product will not begin to split along the crease. If the product then opens back out into a flat piece, again without splitting, the product is considered to have passed this elasticity test to a satisfactory level. The products of the Examples when tested did not split when folded.

The products of the invention show a similar water absorbancy to white bread, and comparable springiness and hardness to commercially available flour tortillas.

1. A food product comprising a mucilaginous hydrocolloid, a mannan-based hydrocolloid, plant derived protein, insoluble fibre and water.

2. A food product according to claim 1, wherein the food product is in granular form.

3. A food product according to claim 1 comprising 3% to 5% by weight of a mucilaginous hydrocolloid, 3% to 5% by weight of a mannan-based hydrocolloid, 20% to 30% by weight of insoluble fibre, 10% to 20% by weight of plant derived protein, 40% to 60% of water, and optionally 5% to 10% by weight of a texture enhancer.

4. (canceled)

5. (canceled)

6. A substantially dehydrated food product comprising a mucilaginous hydrocolloid, a mannan-based hydrocolloid, plant derived protein and insoluble fibre.

7. A substantially dehydrated food product according to claim 6 comprising 3% to 7% by weight of a mucilaginous hydrocolloid, from 3% to 7% by weight of a mannan-based hydrocolloid, between 40% and 60% by weight of insoluble fibre, from 15% to
25% by weight of plant derived protein, from 0% to 5% of water, and optionally from 12% to 17% by weight of a texture enhancer.

8. A food product according to claim 1 wherein the mucilaginous hydrocolloid is psyllium, the mannan-based hydrocolloid is konjac, the insoluble fibre is wheat fibre, and/or the plant derived protein is a protein isolate, suitably a pea or bean protein, mushroom derived protein or potato skin derived protein.

9. (canceled)

10. (canceled)

11. A food product according to claim 1 further comprising a texture enhancer, preferably wherein the texture enhancer is hydroxypropylmethylcellulose (HPMC).

12. (canceled)

13. (canceled)

14. A food product according to claim 1, which comprises less than 3% fat.

15. A food product according to claim 1, wherein the food product does not comprise animal product.

16. A meal item comprising a food product according to claim 1; and one or more additional ingredients, toppings, fillings, dressings, sauces, and/or spreads.

17. A long shelf life food product comprising a food product according to claim 1.

18. A culinary mix comprising two or more ingredients for making a food, wherein one or more of the ingredients is a food product according to claim 1.

19. A food product according to claim 1 wherein the food product is a bakery food product, preferably selected from the group consisting of: pizza base, wrap, flatbread, tortilla, bread, cake, pastry, pancake, roll, waffle and biscuit.

20. (canceled)

21. A method of making a food product, the method comprising the steps of:
i) mixing a mucilaginous hydrocolloid, a mannan-based hydrocolloid, insoluble fibre, and plant derived protein water to provide a liquid mixture;
ii) optionally, applying the liquid mixture onto a baking sheet;
iii) heating the liquid mixture to remove water and provide a substantially dehydrated food product; and optionally
iv) re-hydrating the dehydrated food product of iv); and/or grinding the product of iii) or iv).

22. (canceled)

23. (canceled)

24. (canceled)

25. A substantially dehydrated food product according to claim 4, wherein the food product is in granulated form.

26. A substantially dehydrated food product according to claim 7, wherein the mucilaginous hydrocolloid is psyllium, the mannan-based hydrocolloid is konjac, the insoluble fibre is wheat fibre, and/or the plant derived protein is a protein isolate, suitably a pea or bean protein, mushroom derived protein or potato skin derived protein.

27. A substantially dehydrated food product according to claim 6 which comprises less than 3% fat.

28. A substantially dehydrated food product according to claim 6 wherein the food product does not comprise animal product.

29. A long shelf life food product comprising a food product according to claim 6.

30. A culinary mix comprising two or more ingredients for making a food, wherein one or more of the ingredients is a food product according to claim 6.
